(19) United States
(12) Patent Application Publication
(10) Pub. No.: US 2009/0117360 A1
(43) Pub. Date: May 7, 2009

(54) SELF-ASSEMBLED MATERIAL PATTERN TRANSFER CONTRAST ENHANCEMENT

(75) Inventors: Lawrence A. Clevenger, LaGrangeville, NY (US); Timothy J. Dalton, Ridgefield, CT (US); Habib Hichri, Poughkeepsie, NY (US); Louis L. Hsu, Fishkill, NY (US); Kaushik A. Kumar, Beacon, NY (US); Carl Radens, LaGrangeville, NY (US); Shahab Siddiqui, White Plains, NY (US); Chih-Chao Yang, Glenmont, NY (US)

Correspondence Address: SCULLY, SCOTT, MURPHY & PRESSER, P.C., 400 GARDEN CITY PLAZA, SUITE 300, GARDEN CITY, NY, 11530, US

(73) Assignee: International Business Machines Corporation, Armonk, NY (US)

(21) Appl. No.: 11/933,760

(22) Filed: Nov. 1, 2007

(51) Int. Cl. G03C 1/73; B05D 3/00; B32B 27/06

(52) U.S. Cl. 428/220; 216/11; 427/331; 430/327

(57) ABSTRACT

A non-photosensitive polymeric resist containing at least two immiscible polymeric block components is deposited on the planar surface. The non-photosensitive polymeric resist is annealed to allow phase separation of immiscible components and developed to remove at least one of the at least two polymeric block components. Nanoscale features, i.e., features of nanometer scale, including at least one recessed region having a nanoscale dimension is formed in the polymeric resist. The top surface of the polymeric resist is modified for enhanced etch resistance by an exposure to an energetic beam, which allows the top surface of the patterned polymeric resist to become more resistant to etching processes and chemistries. The enhanced ratio of etch resistance between the two types of surfaces provides improved image contrast and fidelity between areas having the top surface and the at least one recessed region.

### FIELD OF THE INVENTION

The present invention relates generally to semiconductor fabrication, and more particularly, to methods for anisotropic surface treatment of self-assembled nanometer materials prior to pattern transfer to an underlayer in order to improve contrast and fidelity of the pattern transfer, and structures for the same.

### BACKGROUND OF THE INVENTION

The use of bottom-up approaches to semiconductor fabrication has grown in interest within the semiconductor industry. One such approach utilizes self-assembling block copolymers for generation of sublithographic ground rule nanometer scale patterns.

Self-assembling copolymer materials that are capable of self-organizing into nanometer-scale patterns may be applied within a recessed region of a template layer to form a nanoscale structure. Under suitable conditions, the two or more immiscible polymeric block components separate into two or more different phases on a nanometer scale, and thereby form ordered patterns of isolated nano-sized structural units. Such ordered patterns of isolated nano-sized structural units formed by the self-assembling block copolymers can be used for fabricating nano-scale structural units in semiconductor, optical, and magnetic devices. Specifically, dimensions of the structural units so formed are typically in the range of 10 to 40 nm, which are sublithographic (i.e., below the resolution of the lithographic tools).

The self-assembling block copolymers are first dissolved in a suitable solvent system to form a block copolymer solution, which is then applied onto the surface of the first exemplary structure to form a block copolymer layer. The self-assembling block copolymers are annealed at an elevated temperature to form two sets of polymer block structures containing two different polymeric block components. The polymeric block structure may be lines or cylinders. One set of polymer block structures may be embedded in the other set of polymer block structures, or polymeric block structures belonging to different sets may alternate.

The self-assembling resists are non-photosensitive resists, of which the patterning is effected not by photons, i.e., optical radiation, but by self-assembly under suitable conditions such as an anneal.

The boundary between the two sets of polymeric block structures that is formed when the polyneric block components separate is rounded due to surface tension of the polymeric block components. After one of the two sets of polymeric block structures is removed during developing of the block copolymer layer, for example by etching, the remaining set of polymeric block structures, which comprises one of the polymeric block components, have rounded surfaces or insufficient height variation. Such lack of sharpness or lack of sufficient height variation in the profile of the remaining set of polymeric block structures causes lack of contrast during a pattern transfer into an underlying layer. In other words, definition of the boundary between a protected region containing a thicker portion of the polymeric block component and an exposed region containing a thinner portion, or none, of the polymeric block component is fuzzy during a transfer of the pattern of the set of polymeric block structures into the underlying layer. This fuzziness, or lack of contrast, in the profile thus adversely affects transfer of the pattern in the remaining set of polymeric block components by limiting the depth of etch that may be performed into the underlying layer and/or by limiting the sharpness of the transferred pattern in the underlying layer.

In view of the above, there exists a need for methods of enhancing the contrast of the boundary between a region to be protected and a region to be etched prior to transfer of a pattern in a set of polymeric block structures, and structures for the same.

Further, there exists a need for methods of transferring the pattern in the set of polymeric block structures into an underlying layer with enhanced contrast and higher fidelity to the pattern, and structures for the same.

### SUMMARY OF THE INVENTION

The present invention addresses the needs described above by providing a method of enhancing the contrast of a pattern of a set of polymeric block components having a nanoscale dimension by changing chemical properties of a top portion of the polymeric block components to enhance resistivity to oxygen containing etch chemistry, and structures for the same.

The present invention provides methods for anisotropic surface treatment of nanoscale self-assembled structures prior to pattern transfer to an underlayer in order to improve contrast and fidelity of the image, and structures for the same. A non-photosensitive polymeric resist containing at least two immiscible polymeric block components is deposited on the planar surface. For example, the non-photosensitive polymeric resist may be a poly (methyl methacrylate-b-styrene) (PMMA-b-S) based di-block polymeric resist. The non-photosensitive polymeric resist is annealed to allow phase separation of immiscible components and developed to remove at least one of the at least two polymeric block components. Nanoscale features, i.e., features of nanometer scale, including at least one recessed region having a nanoscale dimension is formed in the polymeric resist. The top surface of the polymeric resist is modified for enhanced etch resistance by an exposure to an energetic beam of at least one of ultraviolet photons, optical photons, aerosol particles, ionized atoms, electrons, neutral atoms, neutrons, and protons. The bottom surface of the at least one recessed region is shielded from the energetic beam by directing the energetic beam at an angle to the polymeric resist. This allows the top surface of the patterned polymeric resist to become more resistant to etching processes and chemistries, while etch resistance of the sidewalls and the bottom surface of the at least one recessed region remains the same as prior to the energetic beam treatment. The enhanced ratio of etch resistance between the two types of surfaces provides improved image contrast and fidelity between areas having the top surface and the at least one recessed region. Alternatively, non-conformal dielectric layer may be deposited on a top surface of the polymeric resist, but not on the sidewalls and the bottom surface of the at least one recessed region to provide enhancement to etch resistance to the top surface of the polymeric resist.

According to an aspect of the present invention, a method of forming a nanoscale pattern on a substrate is provided. The method comprises:

applying a non-photosensitive polymeric resist comprising a first polymeric block component and second polymeric block component on an underlayer on a substrate;

forming a nanoscale self-assembled patterned layer comprising the first block component and containing at least one recessed region having a nanoscale lateral dimension; and

exposing an upper portion of the nanoscale self-assembled patterned layer to an energetic beam and causing cross-linking of the first block component, while a lower potion of the nanoscale self-assembled patterned layer is shielded from the energetic beam, wherein the energetic beam comprises at least one of ultraviolet photons, optical photons, aerosol particles, ionized atoms, electrons, neutral atoms, neutrons, and protons.

In one embodiment, the at least one region is shielded from the energetic beam.

In another embodiment, the energetic beam impinges on the nanoscale self-assembled pattern at an angle from a vertical axis.

In even another embodiment, the upper portion is silylated by the energetic beam and is rendered more resistant to an oxygen containing etch chemistry.

In yet another embodiment, the method further comprises etching the at least one region selective to the upper portion.

In still another embodiment, the method further comprises:

forming a template layer on the underlayer; and

patterning the template layer to form a trench in the template layer prior to the applying of the non-photosensitive polymeric resist.

In still yet another embodiment, a top surface of the underlayer is exposed at a bottom of the trench.

In a further embodiment, the method further comprises:

applying a photoresist on the template layer; and

lithographically patterning the photoresist prior to the patterning of the template layer, wherein the trench in the template layer has the same pattern as the lithographically patterned the photoresist.

In an even further embodiment, the trench has a lithographic lateral dimension.

In a yet further embodiment, the nanoscale lateral dimension is less than the lithographic lateral dimension.

According to another aspect of the present invention, another method of forming a nanoscale pattern on a substrate is provided. The method comprises:

applying a non-photosensitive polymeric resist comprising a first polymeric block component and second polymeric block component on an underlayer on a substrate;

forming a nanoscale self-assembled patterned layer comprising the first block component and containing at least one recessed region having a nanoscale lateral dimension; and

depositing a non-conformal dielectric layer on a top surface of the nanoscale self-assembled patterned layer, but not on sidewalls and a bottom surface of the at least one recessed region.

In one embodiment, the method further comprises etching the at least one recessed region selective to the non-conformal dielectric layer.

In another embodiment, the non-conformal dielectric layer comprises a high density plasma (HDP) oxide.

In yet another embodiment, the non-conformal dielectric layer is formed by simultaneous substantially isotropic etching and anisotropic deposition of a dielectric material.

According to yet another aspect of the present invention, a nanoscale structure is provided, which comprises a nanoscale self-assembled patterned layer comprising a non-photosensitive polymeric resist containing one polymeric block component and having an upper portion and a lower portion, wherein the upper portion has a first fraction of the polymeric block component cross-linked, and the lower portion has a second fraction of the polymeric block component cross-linked, wherein the first fraction is greater than the second fraction.

In one embodiment, the self-assembled patterned layer comprises at least one recessed region having sidewalls on which the second fraction of the polymeric block component is cross-linked.

In another embodiment, the at least one recessed region has a nanoscale lateral dimension which is a sublitbographic dimension.

In even another embodiment, the upper portion is more resistant to oxygen containing etch chemistry than the lower region and the at least one recessed region.

In yet another embodiment, a bottom surface of the at least one region is disjoined from a bottom surface of the nanoscale self-assembled patterned layer.

In still another embodiment, the method further comprises an underlayer vertically abutting the bottom portion of the nanoscale self-assembled patterned layer and a top surface of a substrate.

In still yet another embodiment, a top surface of the underlayer is exposed at a bottom of the at least one region.

In a further embodiment, the underlayer contains at least one sublithographic trench directly beneath the at least one recessed region, wherein the at least one recessed region and the at least one sublithographic trench have the same pattern.

In an even further embodiment, the method further comprises a patterned template layer located directly on the underlayer and having sidewalls abutting the lower portion of the nanoscale self-assembled patterned layer.

In a yet further embodiment, the patterned template layer contains a lithographical pattern having a lithographic dimension.

### BRIEF DESRCRIPTION OF THE DRAWINGS

FIGS. 1-11 are sequential views of a first exemplary nanoscale structure according to a first embodiment of the present invention.

FIGS. 12-17 are sequential views of a second exemplary nanoscale structure according to a second embodiment of the present invention.

### DETAILED DESCRIPTION OF THE INVENTION

As stated above, the present invention relates to methods for anisotropic surface treatment of self-assembled nanometer materials prior to pattern transfer to an underlayer in order to improve contrast and fidelity of the pattern transfer, and structures for the same, which are now described in detail with accompanying figures. It is noted that like and corresponding elements are referred to by like reference numerals.

Referring to FIG. 1, a first exemplary nanoscale structure according to a first embodiment of the present invention comprises a substrate 10 and an underlayer 20 disposed directly thereupon. The substrate 10 may be a semiconductor substrate, an insulator substrate, a metallic substrate, or a combination thereof. The semiconductor substrate may be a silicon substrate, other group IV element semiconductor substrate, or a compound semiconductor substrate. Also, the semiconductor substrate may be a bulk substrate, a semiconductor-on-insulator (SOI) substrate, or a hybrid substrate having a bulk portion and an SOT portion. The underlayer 20 may comprise a semiconductor material, an insulator material, and/or a metallic material. The underlayer 20 may be a blanket layer having a homogeneous composition, or may have a pattern of a first material embedded within a second material. For example, a pattern of a semiconductor material or a metallic material may be embedded in an insulator material in the underlayer 20.

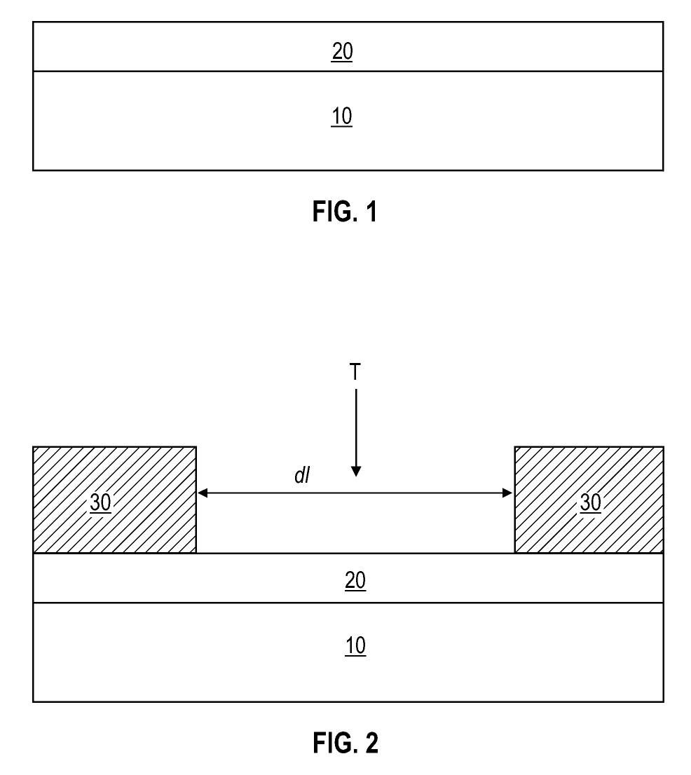

Referring to FIG. 2, a template layer 30 is formed on the underlayer 20 and lithographically patterned. The template layer 30 may comprise a photoresist optionally including a bottom antireflective coating (BARC) and/or a top antireflective coating (TARC). In this case, the template layer 30 is patterned by conventional lithographic techniques including exposure to a light source such as a monochromatic ultraviolet light beam, followed by development of the photoresist to form a pattern in the remaining portion. The photoresist may be a positive photoresist or a negative photoresist. Alternately, the template layer 30 may comprise a dielectric material or a semiconductor material. For example, the template layer 30 may comprise silicon oxide, silicon nitride, a low-k dielectric material, polysilicon, or a polycrystalline silicon germanium alloy. In this case, the template layer 30 is patterned by applying a conventional photoresist on the template layer, lithographically patterning the photoresist, and transferring the pattern on the photoresist into the template layer 30 by etching employing, for example, a reactive ion etch. Use of the template layer 30 is preferred but is not required for practicing the present invention. Embodiments in which the template layer 30 is omitted are explicitly contemplated herein.

The exposed region of the template layer 30 surrounded by the template layer 30 forms a trench T having a lithographic dimension dl.

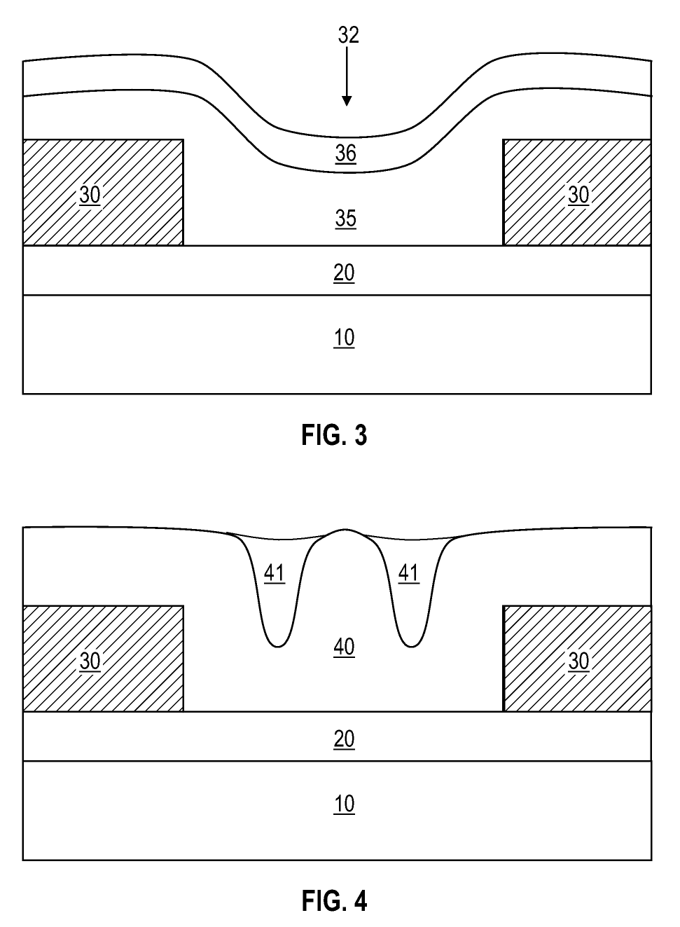

Referring to FIG. 3, a non-photosensitive polymeric resist comprising self-assembling block copolymers that are capable of self-organizing into nanometer-scale patterns is applied over the underlayer 20 within an opening 32 in the template layer 30 to form a first polymeric block component layer 35 and a second polymeric block component layer 36. The first polymeric block component layer 35 comprises a first polymeric block component and a second polymeric block component layer 36 comprises a second polymeric block component. The first polymeric block component and the second polymeric block component are immiscible with each other. The non-photosensitive polymeric resist (35, 36) may be self-planarizing, i.e., has a substantially planar top surface, or may be partially conformal, in which case a depression 32 may be formed in an area not containing the template layer 30.

Under suitable conditions, the two immiscible polymeric block components separate into different phases on a nanometer scale and thereby form ordered patterns of isolated nano-sized structural units, or nanoscale structures. Such ordered patterns of isolated nano-sized structural units formed by the self-assembling block copolymers can be used for fabricating nano-scale structural units in semiconductor, optical, and magnetic devices. Specifically, dimensions of the structural units so formed are typically in the range of 10 to 40 nm, which are sublithographic (i.e., below the resolutions of the lithographic tools).

While a “lithographic minimum dimension” and a “sublithographic dimension” are defined only in relation to a lithography tool and normally changes from generation to generation of semiconductor technology, it is understood that the lithographic minimum dimension and the sublithographic dimension are to be defined in relation to the best performance of lithography tools available at the time of semiconductor manufacturing. As of 2007, the lithographic minimum dimension is about 50 nm and is expected to shrink in the future.

Exemplary materials for the first polymeric block component layer 35 and the second polymeric block component layer 36 are described in commonly-assigned, copending U.S. patent application Ser. No. 11/424,963, filed on Jun. 19, 2006, the contents of which are incorporated herein by reference. Specific examples of self-assembling block copolymers for the non-photosensitive polymeric resist (35, 36) that can be used for forming the structural units of the present invention may include, but are not limited to: polystyrene-block-polymethylmethacrylate (PS-b-PMMA), polystyrene-block-polyisoprene (PS-b-PI), polystyrene-block-polybutadiene (PS-b-PBD), polystyrene-block-polyvinylpyridine (PS-b-PVP), polystyrene-block-polyethyleneoxide (PS-b-PEO), polystyrene-block-polyethylene (PS-b-PE), polystyrene-b-polyorganosilicate (PS-b-POS), polystyrene-block-polyferrocenyldimethylsilane (PS-b-PFS), polyethyleneoxide-block-polyisoprene (PEO-b-PEE), polyethyleneoxide-block-polybutadiene (PEO-b-PBD), polyethyleneoxide-block-polymethylmethacrylate (PEO-b-PMMA), polyethyleneoxide-block-polyethylethylene (PEO-b-PEE), polybutadiene-block-polyvinylpyridine (PBD-b-PVP), and polyisoprene-block-polymethylmethacrylate (PI-b-PMMA). The self-assembling block copolymers are first dissolved in a suitable solvent system to form a block copolymer solution, which is then applied onto the surface of the first exemplary structure to form the non-photosensitive polymeric resist (35, 36). The solvent system used for dissolving the block copolymer and forming the block copolymer solution may comprise any suitable solvent, including, but not limited to: toluene, propylene glycol monomethyl ether acetate (PGMEA), propylene glycol monomethyl ether (PGME), and acetone. The non-photosensitive polymeric resist (35, 36) is not a conventional photoresist that may be developed upon exposure to ultraviolet light or optical light. Also, the non-photosensitive polymeric resist (35, 36) is not a conventional low-k dielectric material.

In one illustrative case, a “honeycomb” structure is formed with in a poly (methyl methacrylate b-styrene) (PMMA-b-S) block copolymer. In the case of cylindrical phase diblock, the PMMA-b-S block can separate to form vertically oriented cylinders within the matrix of the polystyrene block upon thermal annealing.

In a variation of the first embodiment, the template layer 30 may be omitted and the non-photosensitive polymeric resist (35, 36) may be planar. The nanoscale structures may be formed without the effect of the template layer 30 in this case.

Referring to FIG. 4, formation of self-assembled nanoscale structures is shown, during which cross-linking of the self-assembling block copolymers upon annealing. Specifically, the first exemplary nanoscale structure is annealed by ultraviolet treatment or by thermal annealing at an elevated temperature to form a cross-linked polymeric block component layer 40 having at least one recessed region 60. The cross-linked polymeric block component layer 40 may comprise the first polymeric block component or a second polymeric block component, in which polymeric block components are cross-linked by the ultraviolet treatment or the thermal anneal. The remaining polymeric block component is separated from the cross-linked polymeric block component layer 40 to from at least one complementary block component structure 41.

In case the template layer 30 is employed, the pattern in the cross-linked polymeric block component layer 40 may be guided by the topography of the template layer 30.

Exemplary processes of annealing the self-assembling block copolymers in the block copolymer layer to form two sets of polymer blocks are described in Nealey et al., “Self-assembling resists for nanolithography,” IEDM Technical Digest, December, 2005, Digital Object Identifier 10.1109/IEDM.2005.1609349, the contents of which are incorporated herein by reference. Methods of annealing described in the '963 Application maybe employed. The anneal may be performed, for example, at a temperature from about 200° C. to about 300° C. for a duration from less than about 1 hour to about 100 hours.

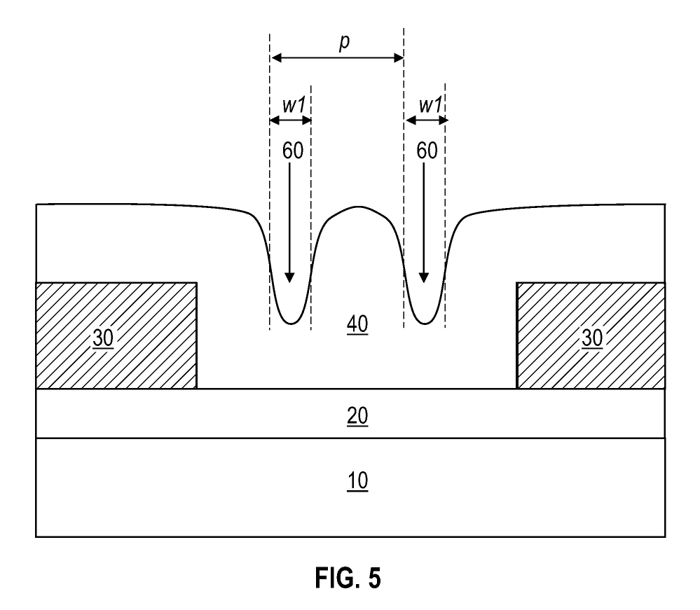

Referring to FIG. 5, the at least one complementary block component structure 41 is removed employing evaporation by heating on a developer and or an etch that removed the at least one complementary block component structure 41 selective to the cross-linked polymeric block component layer 40. The etch may be a wet etch or a dry etch.

The at least one recessed region has a first nanoscale lateral dimension w1, which maybe the width of the at least one recessed region 60 as measured at a half height of the at least one recessed region 60. The half height is the mathematical mean of the height of a top surface of the cross-linked polymeric block component layer 40 and the height of a bottom surface of the at least one recessed region 60. Other metrics, such as a diameter of a cylinder with a circular horizontal cross-section or a length of a major axis of an elliptic cylinder, may be employed depending on the geometrical shape of the at least one recessed region 60.

The cross-linked polymeric block component layer 40 is homogeneous, i.e., the composition, chemical properties, and physical properties are the same across the cross-linked polymeric block component layer 40. Particularly, the degree of cross-linking is the same across the cross-linked polymeric block component layer 40. The cross-linked polymeric block component layer 40 being a homogenous structure, it is clear that there is no contrast or selectivity to a pattern transfer process. In other words, all portions of the cross-linked polymeric block component layer 40 are consumed at an equal rate during the pattern transfer process such as a reactive ion etch. In some pattern transfer processes in which the geometry of the cross-linked polymeric block component layer 40 protects removal or etching of the at least one recessed region 60, the pattern transfer process may even deteriorate the fidelity of the existing pattern by flattening the cross-linked polymeric block component layer 40 during the pattern transfer. The lack of fidelity may be due to lack of sufficient height variation in the profile of the cross-linked polymeric block component layer 40, sloped sidewalls of the at least one recessed region, or a combination of both.

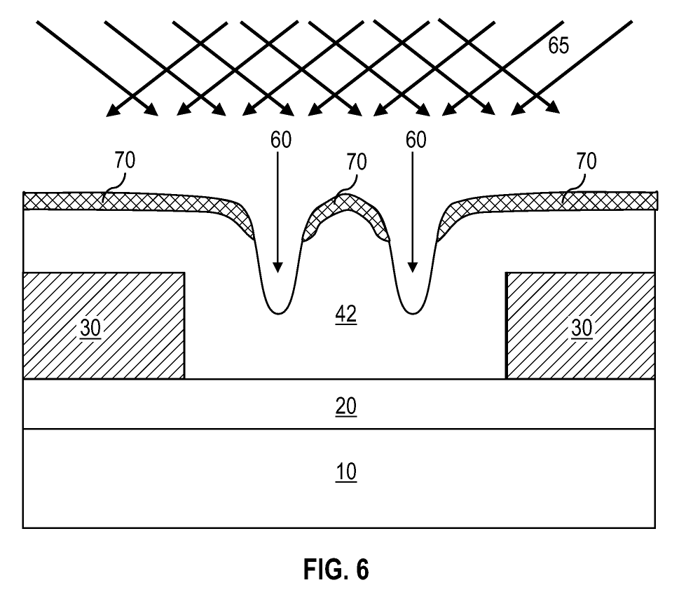

Referring to FIG. 6, the field area of the cross-linked polymeric block component layer 40 is hardened by exposure to an energetic beam 65 at an angle. The angle of the energetic beam 65 is selected such that particles of the energetic beam 65 impinges on top surfaces of the cross-linked polymeric block component layer 40, while sidewalls and a bottom surface of the at least one recessed region 60 is protected from the energetic beam 65. The angle and the energy of the energetic beam 65 is determined such that energy transfer into the cross-linked polymeric block component layer 40 is sufficient to cause a chemical change, specifically, to induce further cross-linking of the in the cross-linked polymeric block component layer 40.

The energetic beam 65 comprises at least one of ultraviolet photons, optical photons, aerosol particles, ionized atoms, electrons, neutral atoms, neutrons, and protons. Gamma ray or X-ray may also be employed. The angle of incidence herein denotes the angle between the direction of the energetic beam 65 and a surface normal of an idealized planar top surface of the cross-linked polymeric block component layer 40, which is the same as the surface normal of the underlying layer 20. The angle of incidence is non-zero, and is sufficiently large to avoid impinging of the energetic beam 65 on the sidewalls and the bottom surface of the at least one recessed region 60 below a top region of the cross-linked polymeric block component layer 40. Practically, the angle of incidence may be from about 10 degrees to 90 degrees, and preferably from about 20 degrees to 90 degrees. The range of angle may vary depending on the nature of the energetic beam 65. For example, ionized atoms, which are typically delivered by conventional ion implantation, may have an incidence angle from about 20 degrees to about 45 degrees. Aerosol particles may have an incidence angle close to 90 degrees. One or many incidence angles may be employed. The same incidence angle having a different direction of the energetic beam 65, i.e., incidence from a left side and from a right side, may be employed as well. The non-zero incidence angle minimize the interaction of the energetic beam 65 with the sidewalls and the bottom surface of the at least one recessed region 60 to avoid any reaction therein. The energy of the energetic beam 65 is selected to enable transfer of sufficient energy into the cross-linked polymeric block component to effect chemical changes such as cross-linking and/or silylation of the cross-linked polymeric block component layer 40 near a top surface.

The portion of the cross-linked polymeric block component layer 40 that has enhanced cross-linking of the polymeric block component is herein referred to as a top portion 70. The remaining portion of the cross-linked polymeric block component layer 40 that maintain the same level of cross-linking of the polymeric block component is herein referred to as a bottom portion 42.

As a result of the surface treatment, the material properties of the top portion 70 are modified from the material properties of the bottom portion 42. For example, the top portion 70 may have a higher material density than the bottom portion 42. Particularly, the upper portion 70 may be silylated by the energetic beam, and consequently, be rendered more resistant to oxygen containing etch chemistry. Silylation is substitutional replacement of an active hydrogen of a protic material (—OH, —NH, —SH) with a silicon atom. The silylation of organic compounds is a technique that has been known but has only recently been used to alter the development rate of polymeric resists and to improve the resistance to reactive ion etching (RIE) in O₂ plasma. The loss of the protic material during the silylation process causes the upper portion 70 to become denser and more resistant to oxygen containing etch chemistry than the bottom portion 42.

The angled incidence of the energetic beam silylates only the top portion 70 of the cross-linked polymeric block component layer (70, 42), while the bottom portion 42 is not silylated by the energetic beam. Further, the top portion 70 and the bottom portion 42 of the cross-linked polymeric block component layer (70, 42) are not photosensitive in a conventional sense. Exposure to ultraviolet or optical radiation of the cross-linked polymeric block component layer (70, 42) does not form materials that may be developed by conventional lithographic techniques, but results in hardening, or increase in cross-linking of the polymeric block component in the top portion 70, which is manifested in increase in etch resistance during an oxygen based etch, e.g., a reactive ion etch in O₂ plasma.

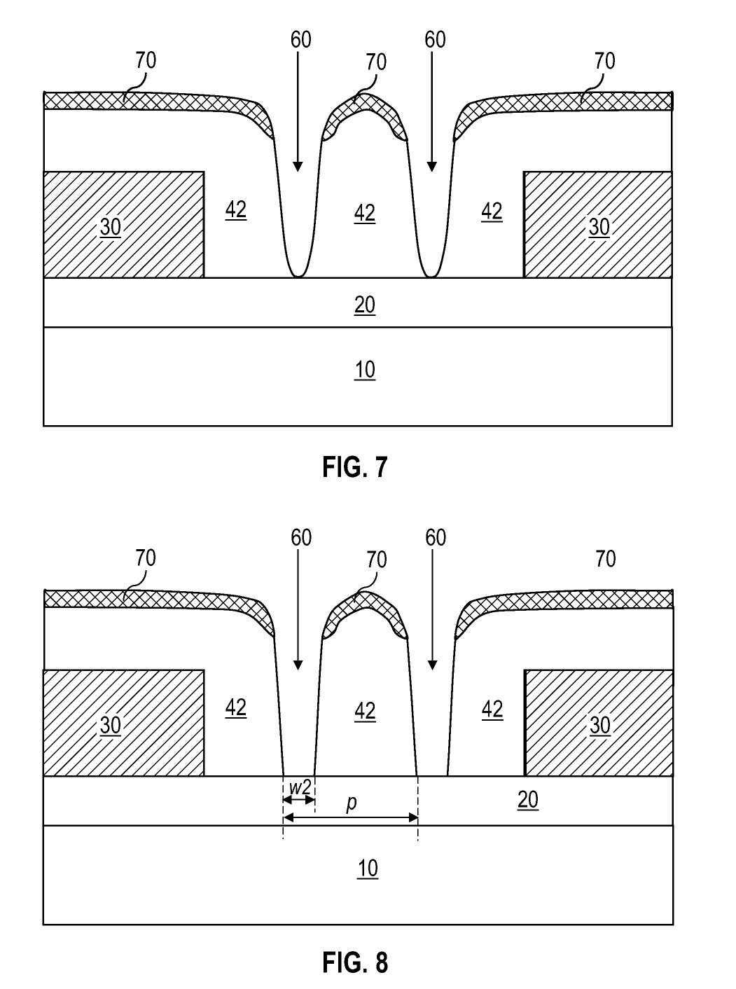

Referring to FIG. 7, the at least one recessed region 60 is further recessed by an etch selective to the top portion 70 until a portion of the underlying layer 20 is exposed. The etch may be a wet etch, or preferably, a reactive ion etch, which preferably employs O₂ plasma. Less material is consumed per area in the top portion 40 relative to inside the at least one recessed region 60, since the bottom surface and the sidewall surface of the at least one recessed region has the same etch resistance as prior to the energetic beam treatment, while the top portion 70 has enhanced etch resistance due to the energetic beam treatment. Thus, the pattern in the cross-linked polymeric block component layer (70, 42) is enhanced in terms of contrast and fidelity. The range of the height variation in the cross-linked polymeric block component layer (70, 42) increases, while the slope of sidewalls of the at least one recessed region becomes steeper

Referring to FIG. 8, the etch continues until an exposed area has a second nanoscale lateral dimension w2, which may be a lateral width of a trench or a diameter, a dimension of a major axis or minor axis of an elliptical via. The second nanoscale lateral dimension w2 has a nanoscale dimension, which may be from about 10 nm to about 40 nm. The second nanoscale lateral dimension w2 is on the order of the first nanoscale lateral dimension w1. Typically, the second nanoscale lateral dimension w2 is a sublithographic dimension. In case multiple recessed regions 60 are present, the pitch p between adjacent recessed regions 60 may be a nanoscale dimension. Residual material at the bottom of the at least one recessed region 60 may be cleaned as necessary, for example, by a wet etch.

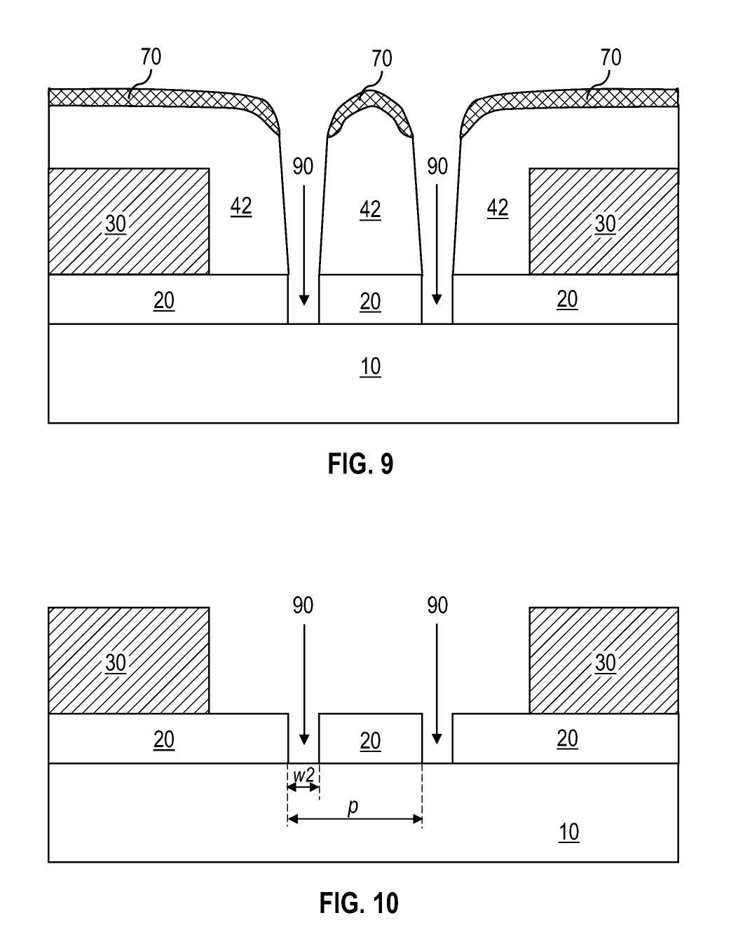

Referring to FIG. 9, the pattern of the at least one recessed region 60 is transferred into the underlayer 20 by a reactive ion etch to form at least one nanoscale pattern 90 in the underlayer 20. The enhanced etch resistivity of the top portion 70 relative to the bottom portion 42 is leveraged to enhance the contrast and sharpness of the at least one nanoscale pattern 90 in the underlayer 20. The reactive ion etch may employ CFₓ plasma.

Referring to FIG. 10, the top portion 70 and the bottom portion 42 of the cross-linked polymeric block component layer are removed, for example, by a plasma etch or a wet etch.

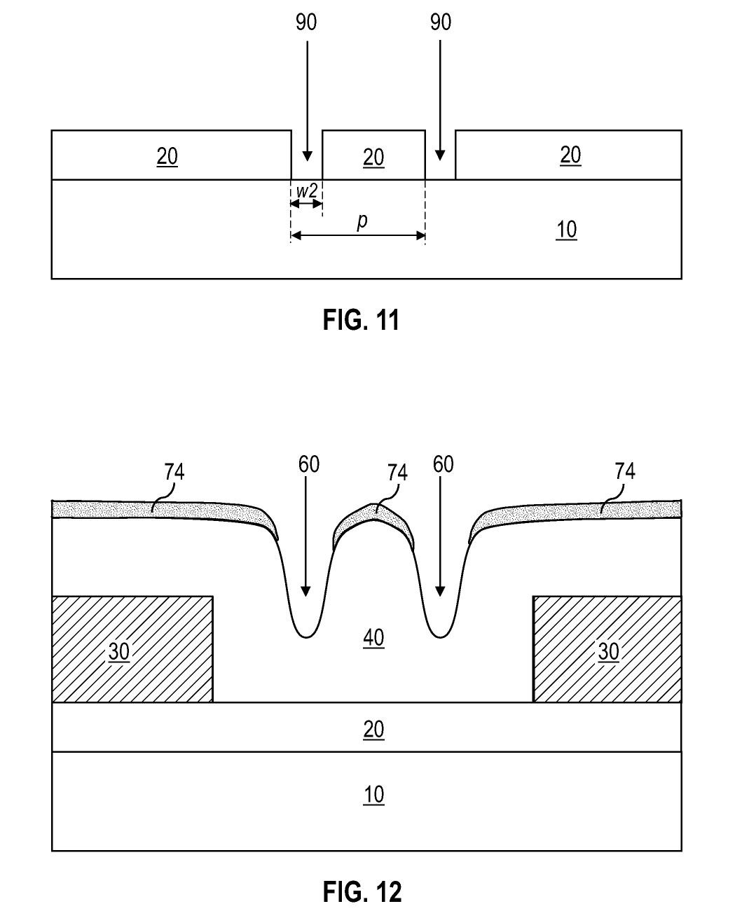

Referring to FIG. 11, the template layer 30 may also be removed by another plasma etch or another wet etch. In case the template layer 30 comprises a photoresist, conventional photoresist removal process may be employed. In case the template layer 30 comprises a dielectric material or a semiconductor material, a suitable etch chemistry that removed the template layer 30 selective to the underlayer 20 may be employed. The first exemplary nanoscale structure contains at least one nanoscale pattern 90 in the underlayer 20. The at least one nanoscale pattern in the first exemplary nanoscale structure may have a second nanoscale lateral dimension w2, which is preferably a sublithographic dimension.

Referring to FIG. 12, a second exemplary nanoscale structure is derived from the first exemplary nanoscale structure of FIG. 5 by depositing a non-conformal dielectric layer 74 on a top surface of the cross-linked polymeric block component layer 40, which is a nanoscale self-assembled patterned layer. The non-conformal dielectric layer 74 is not deposited on sidewalls and a bottom surface of the at least one recessed region 60. The non-conformal dielectric layer 74 may be formed by simultaneous substantially isotropic etching and anisotropic deposition of a dielectric material such as high density plasma (HDP) deposition of a dielectric material. For example, the dielectric material may comprise a high density plasma (HDP) oxide. The non-conformal dielectric layer 74 has a higher etch resistance than the cross-linked polymeric block component layer 40.

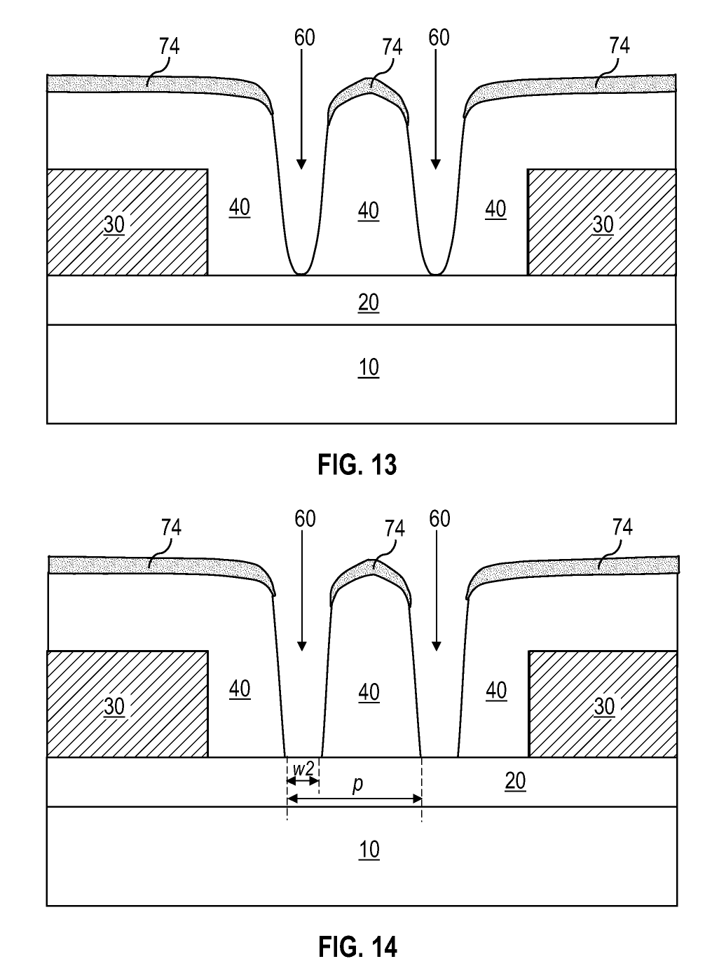

Referring to FIG. 13, the at least one recessed region 60 is further recessed by an etch selective to the non-conformal dielectric layer 74 until a portion of the underlying layer 20 is exposed. The etch may be a wet etch, or preferably, a reactive ion etch. Less material is consumed per area in the non-conformal dielectric layer 74 relative to inside the at least one recessed region 60, since the non-conformal dielectric layer 74 has higher etch resistance than the cross-linked polymeric block component layer 40. Thus, the pattern in the cross-linked polymeric block component layer 40 is enhanced in terms of contrast and fidelity. The range of the height variation in the cross-linked polymeric block component layer 40 increases, while the slope of sidewalls of the at least one recessed region becomes steeper.

Referring to FIG. 14, the etch continues until an exposed area has a second nanoscale lateral dimension w2, which may be a lateral width of a trench or a diameter, a dimension of a major axis or minor axis of an elliptical via. Typically, the second nanoscale lateral dimension w2 is a sublithographic dimension. In case multiple recessed regions 60 are present, the pitch p between adjacent recessed regions 60 may be a nanoscale dimension. Residual material at the bottom of the at least one recessed region 60 may be cleaned as necessary, for example, by a wet etch.

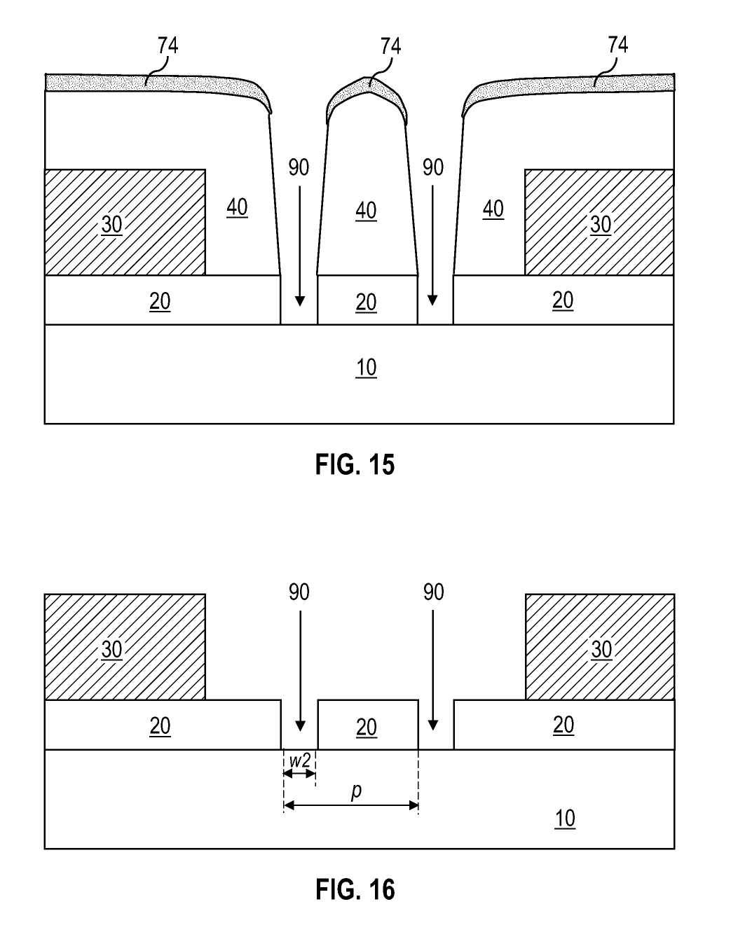

Referring to FIG. 15, the pattern of the at least one recessed region 60 is transferred into the underlayer 20 by a reactive ion etch to form at least one nanoscale pattern 90 in the underlayer 20 as in the first embodiment. The higher etch resistivity of the non-conformal dielectric layer 74 relative to the cross-linked polymeric block component layer 40 is leveraged to enhance the contrast and sharpness of the at least one nanoscale pattern 90 in the underlayer 20.

Referring to FIG. 16, the cross-linked polymeric block component layer 40 is removed, for example, by a plasma etch or a wet etch.

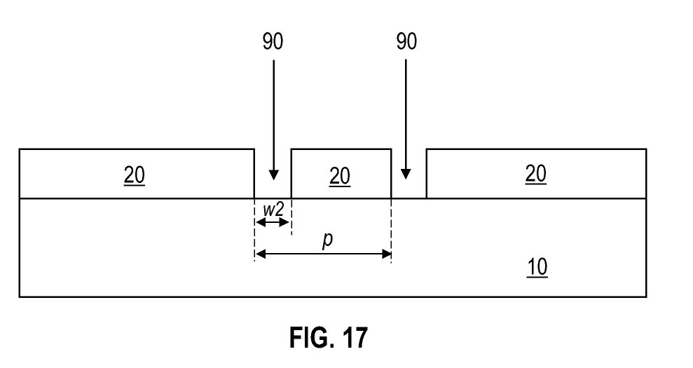

Referring to FIG. 17, the template layer 30 may also be removed by another plasma etch or another wet etch as in the first embodiment. The at least one nanoscale pattern in the second exemplary nanoscale structure may have a second nanoscale lateral dimension w2, which is preferably a sublithographic dimension.

While the invention has been described in terms of specific embodiments, it is evident in view of the foregoing description that numerous alternatives, modifications and variations will be apparent to those skilled in the art. Accordingly, the invention is intended to encompass all such alternatives, modifications and variations which fall within the scope and spirit of the invention and the following claims.

1. A method of forming a nanoscale pattern on a substrate, said method comprising:
applying a non-photosensitive polymeric resist comprising a first polymeric block component and a second polymeric block component on an underlayer on a substrate;
forming a nanoscale self-assembled patterned layer comprising said first block component and containing at least one recessed region having a nanoscale lateral dimension directly on said underlayer, wherein an entirety of said at least one recessed region is contiguously covered with said first block component, and wherein said nanoscale self-assembled patterned layer overlies an entirety of said underlayer;
exposing an upper portion of said nanoscale self-assembled patterned layer to an energetic beam and causing cross-linking of said first block component, while said at least one recessed region of said nanoscale self-assembled patterned layer is shielded from said energetic beam, wherein said upper portion is located above said at least one recessed region, and wherein said energetic beam comprises at least one of ultraviolet photons, optical photons, aerosol particles, ionized atoms, electrons, neutral atoms, neutrons, and protons; and
removing said first block component in said at least one recessed region selective to said upper portion layer, wherein a portion of said underlayer is exposed after said removing of said first block component.

2. The method of claim 1, wherein said at least one recessed region is shielded from said energetic beam.

3. The method of claim 1, wherein said energetic beam impinges on said nanoscale self-assembled pattern at an angle from a vertical axis.

4. The method of claim 1, wherein said upper portion is silylated by said energetic beam and is rendered more resistant to an oxygen containing etch chemistry.

5. The method of claim 1, further comprising etching said at least one recessed region selective to said upper portion.

6. The method of claim 1, further comprising:
forming a template layer on said underlayer; and
patterning said template layer to form a trench in said template layer prior to said applying of said non-photosensitive polymeric resist.

7. The method of claim 6, wherein a top surface of said underlayer is exposed at a bottom of said trench.

8. The method of claim 6, further comprising:
applying a photoresist on said template layer; and
lithographically patterning said photoresist prior to said patterning of said template layer, wherein said trench in said template layer has the same pattern as said lithographically patterned said photoresist.

9. The method of claim 6, wherein said trench has a lithographic lateral dimension.

10. The method of claim 9, wherein said nanoscale lateral dimension is less than said lithographic lateral dimension.

11. A method of forming a nanoscale pattern on a substrate, said method comprising:
applying a non-photosensitive polymeric resist comprising a first polymeric block component and a second polymeric block component on an underlayer on a substrate;
forming a nanoscale self-assembled patterned layer comprising said first block component and containing at least one recessed region having a nanoscale lateral dimension directly on said underlayer, wherein an entirety of said at least one recessed region is contiguously covered with said first block component, and wherein said nanoscale self-assembled patterned layer overlies an entirety of said underlayer;
depositing a non-conformal dielectric layer on a top surface of said nanoscale self-assembled patterned layer, but not on sidewalls and a bottom surface of said at least one recessed region; and
removing said first block component in said at least one recessed region selective to said non-conformal dielectric layer, wherein a portion of said underlayer is exposed after said removing of said first block component.

12. The method of claim 11, further comprising etching said at least one recessed region selective to said non-conformal dielectric layer.

13. A nanoscale structure comprising a nanoscale self-assembled patterned layer and an underlayer located upon a substrate, wherein said nanoscale self-assembled patterned layer is located directly on said underlayer and comprises a non-photosensitive polymeric resist containing a polymeric block component and having an upper portion and at least one recessed region having a nanoscale lateral dimension, wherein an entirety of said at least one recessed region is contiguously covered with said first block component, wherein said upper portion is located above said at least one recessed region, wherein said upper portion has a first fraction of said polymeric block component cross-linked, and said at least one recessed region has a second fraction of said polymeric block component cross-linked, wherein said first fraction is greater than said second fraction, and wherein said nanoscale self-assembled patterned layer overlies an entirety of said underlayer.

14. The nanoscale structure of claim 13, wherein said self-assembled patterned layer comprises at least one recessed region having sidewalls on which said second fraction of said polymeric block component is cross-linked.

15. The nanoscale structure of claim 14, wherein said at least one recessed region has a nanoscale lateral dimension which is a sublithographic dimension.

16. The nanoscale structure of claim 14, wherein said upper portion is more resistant to oxygen containing etch chemistry than said lower region and said at least one recessed region.

17. The nanoscale structure of claim 16, wherein a bottom surface of said at least one recessed region is disjoined from a bottom surface of said nanoscale self-assembled patterned layer.

18. The nanoscale structure of claim 16, further comprising an underlayer vertically abutting said bottom portion of said nanoscale self-assembled patterned layer and a top surface of a substrate.

19. The nanoscale structure of claim 18, wherein a top surface of said underlayer is exposed at a bottom of said at least one recessed region.

20. The nanoscale structure of claim 18, wherein said underlayer contains at least one sublithographic trench directly beneath said at least one recessed region, wherein said at least one recessed region and said at least one sublithographic trench have the same pattern.
